(19) United States
(12) Patent Application Publication
(10) Pub. No.: US 2002/0063370 A1
(43) Pub. Date: May 30, 2002

(54) Chuck for microscopic contacts

(76) Inventor: Akira Osanai, Tokyo (JP)

Correspondence Address: FLYNN, THIEL, BOUTELL & TANIS, P.C., 2026 Rambling Road, Kalamazoo, MI, 49008-1699, US

(21) Appl. No.: 09/995,230

(22) Filed: Nov. 27, 2001

(30) Foreign Application Priority Data
Nov. 28, 2000 (JP) 2000-361610

(51) Int. Cl. B25B 11/00

(52) U.S. Cl. 269/21

(57) ABSTRACT

A chuck for microcontacts for gripping each microcontact with stable and strong holding force and conveying each gripped microcontact to a given mounting position. The chuck for microcontacts comprises a table, an elastic member provided to be movable toward or away from the table by air suction wherein the the micropinis inserted into a groove defined in the table, and the elastic member is pressed down toward the table by air suction so as to grip the the micropin.

### BACKGROUND OF THE INVENTION

1. Field of the Invention

The invention relates to a chuck for microscopic contacts (hereinafter referred to as microcontacts) for gripping microcontacts such as micropins and the like which are used for terminals of electronic devices and the like and for conveying them to a given mounting position. Particularly, the invention relates to a chuck for microcontacts for use in manufacturing a contact board employing micropins as contacts for measuring wafers.

2. Description of the Related Art

An information communication equipment represented by a personal computer or a portable telephone has been recently required to be more small sized with high performance in a market. Accordingly, devices used in the information communication equipment are advanced in more miniaturization with high integration density so that wiring pitches of the devices are rendered narrow. It is known to use micropins serving as contacts for a contact board to measure wafer chips which are narrowed in a wiring pitch.

FIG. 3 is a perspective view showing a conventional chuck, and FIG. 4 is a view showing micropins arranged on a molding sheet. A micropin P is a microscopic elastic member formed by electrolytic plating an S-shaped Au wire with an Ni alloy shown in FIGS. 3 and 4. A chuck 30 is used for gripping and taking out each micropin P from a molding sheet 50 shown in FIG. 4 so as to convey it to a mounting position of a substrate.

The conventional chuck 30 comprises a porous block 10 filled with porous materials at the center, an air connector 11 fixed to one side of the porous block 10 and a vacuum generator 12 connected to the air connector 11 as shown in FIG. 3. The porous block 10 is movable by a moving unit, not shown.

FIGS. 5 (A) to (D) show steps of gripping each micropin P from the molding sheet, FIG. 6 shows a state where each micropin P is mounted on a contact board and FIG. 7 shows a state where the micropin P is subjected to a laser welding. As shown in the step of FIG. 5 (A), the porous block 10 of the chuck 30 is disposed in the vicinity of the molding sheet 50 on which each micropin P is disposed. As shown in the step of FIG. 5 (B), the porous block 10 is positioned in front of each micropin P to be gripped and taken out by the moving unit, not shown.

In the step of FIG. 5 (C), the porous block 10 is brought into contact with each micropin P, then air is sucked by the vacuum generator 12, so that air inside the porous portions of the porous block 10 is sucked by way of the air connector 11. As a result, a space between the micropin P and porous holes blocked by the micropin P is rendered in a vacuum state so that each micropin P is drawn by the porous block 10.

In the step of FIG. 5 (D), when the porous block 10 is moved away from the molding sheet 50, each micropin P is peeled off or taken out from the molding sheet and gripped by the porous block 10. The porous block 10 is moved while it keeps to draw each gripped micropin P, so that each micropin P is conveyed to, e.g., a given mounting position of a contact board 60 as shown in FIG. 6. Each pad 61 is previously installed on the contact board 60 at each mounting position. After each micropin P is disposed on each pad 61, each pad 61 is irradiated with a laser light L, thereby welding each micropin P to each pad 61 as shown in FIG. 7.

Since the foregoing each micropin P is very small in an area to be drawn, e.g., having a width 0.05 mm and a size (length) of 1.5 mm, so that the holding force caused by the suction by the porous block 10 is weak. Further, the positions of porous holes are not stable and air is leaked through the porous holes so that a sufficient holding force is not obtained.

### SUMMARY OF THE INVENTION

In view of the foregoing circumstances, it is an object of the invention to provide a chuck for microcontacts for gripping microcontacts such as micropins and the like with a stable strong holding force and suitably conveying the microcontacts to a given mounting position.

To achieve the above object, a chuck (20) for microcontacts according to a first aspect of the invention is characterized in comprising a movably supported body (21), an elastic member (26) provided to be movable toward or away from the body (21), and a microcontact fixing part (22) formed between the body (21) and the elastic member (26) for sandwiching each microcontact (P) therebetween.

A second aspect of the invention is characterized in further comprising suction means (23, 24) provided on the body (21) for sucking the elastic member (26), wherein the elastic member (26) is moved toward or away from the body (21) by the suction means (23, 24).

A third aspect of the invention is characterized in that a suction force produced by the suction means (23, 24) is changeable, and when the suction force produced by the suction means (23, 24) is changed, a force for holding each microcontact (P) between the body (21) and the elastic member (26) is changed.

A fourth aspect of the invention is characterized in that the microcontact fixing part (22) is a groove defined in the body (21) or the elastic member (26).

A fifth aspect of the invention is characterized in that spacer (25) is sandwiched between the body (21) and elastic member (26), and the elastic member (26) is moved toward or away from the body (21) when the elastic member (26) is elastically deformed.

The foregoing reference numerals in the parentheses are provided for comparing with drawings, and they do not limit the construction of the invention.

### BRIEF DESCRIPTION OF THE DRAWINGS

FIG. 1 is a perspective view showing a chuck for microcontacts according to a preferred embodiment of the invention;

FIGS. 2 (A), (B) are views showing a state where each micropin is gripped by a chuck for microcontacts of the invention;

FIG. 3 is a perspective view showing a conventional chuck for microcontacts;

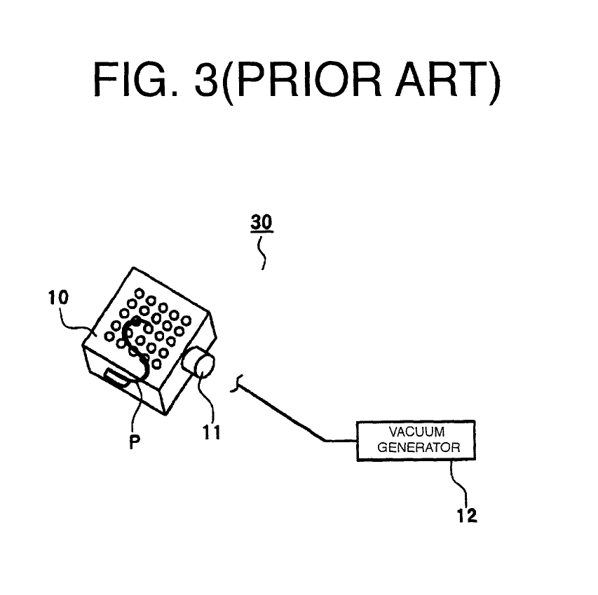

FIG. 4 is a view showing micropins arranged on a molding sheet;

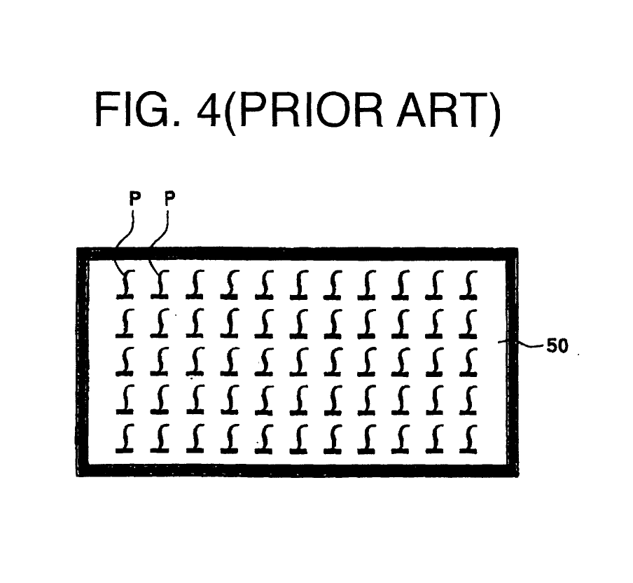

FIG. 5 (A) to (D) are views showing steps of gripping each micropin;

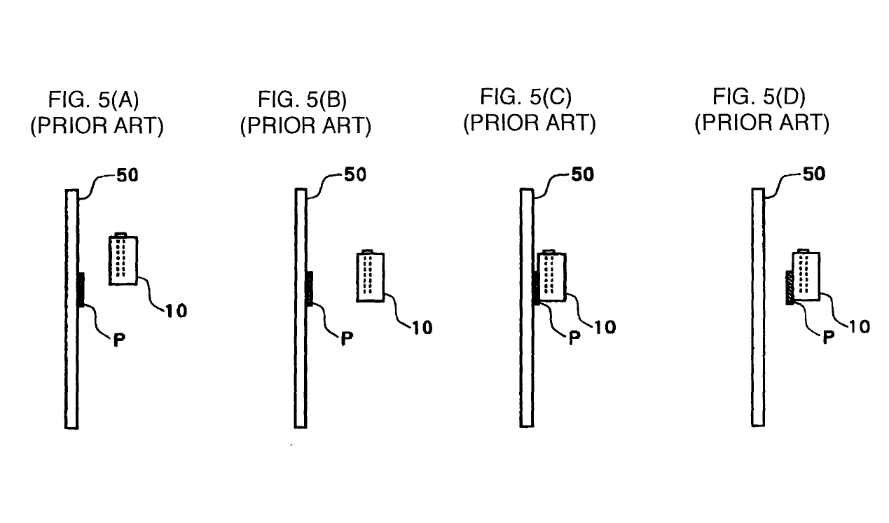

FIG. 6 is a view showing a state where each micropin is mounted on a contact board; and

FIG. 7 is a view showing a state where the micropin is subjected to a laser welding.

### PREFERED ENBODIMENT OF THE INVENTION

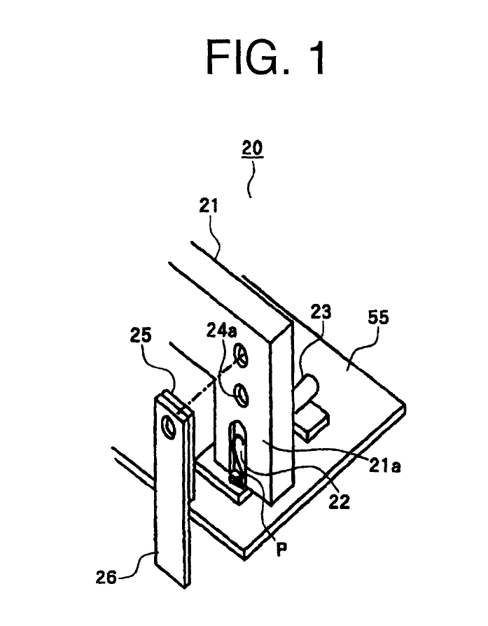

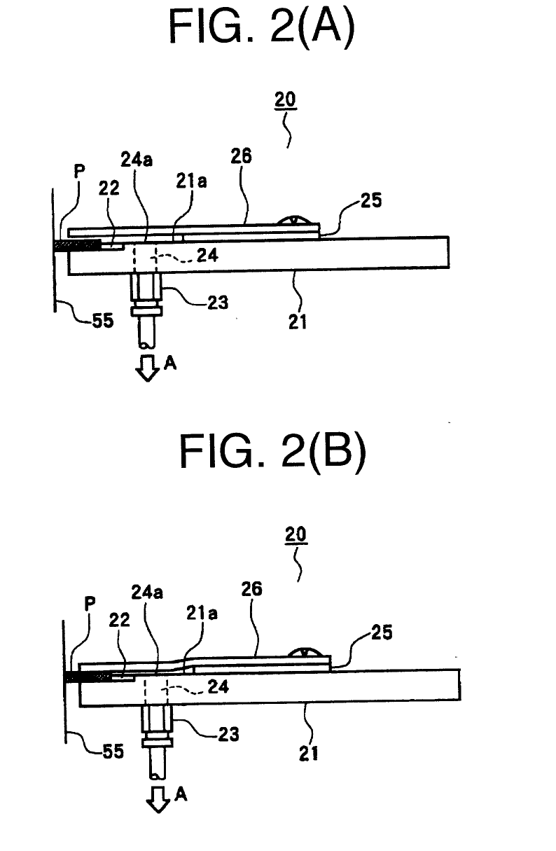

FIG. 1 is a perspective view showing a chuck for microcontacts according to a preferred embodiment of the invention, FIGS. 2 (A), (B) are views showing a state where each micropin P is gripped by a chuck for microcontacts of the invention. A chuck 20 for microcontacts according to the preferred embodiment of the invention has, as shown in FIGS. 1 and 2, a table (body) 21 which is movable by a moving unit, not shown. A surface 21a of the table 21 is formed in a substantially plane and has a groove (microcontact fixing part) 22 in which each micropin P serving as microcontact is inserted.

An air connector 23, which is connected to a vacuum generator, not shown, is provided on the table 21, and a through hole 24 penetrating the table 21 is defined in the table 21 to communicate with the air connector 23. The vacuum generator, the air connector 23, the through hole 24 constitute suction means. The through hole 24 has an air suction port 24a on the surface 21a of the table 21. Aplate-like part (elastic member) 26 is attached to the surface 21a of the table 21 by way of a plate-like spacer 25. The spacer 25 does not exist at the portion where the groove 22 and the air suction port 24a are provided, and there is formed a slight gap between the surface 21a and the plate-like part 26 at this portion.

Since the chuck 20 is structured as set forth above, each micropin P is gripped and taken out, and conveyed to a given mounting position using the chuck 20 are effected in the following manner. The table 21 is first moved by a moving unit, not shown, so as to be positioned relative to each micropin P which stands upright on a sheet 55. Then, the table 21 is forced to approach the sheet 55 so as to insert each micropin P into the groove 22 as shown in FIG. 2 (A).

Subsequently, air is sucked by a vacuum generator, not shown (see the arrow Ain FIG. 2). As a result of the suction of air, air pressure between the plate-like part 26 and the surface 21a of the table 21 is reduced so that the plate-like part 26 is bent at the tip end of the spacer 25 and pressed down toward the surface 21a of the table 21 as shown in FIG. 2 (B). At that time, each micropin P which is inserted into the groove 22 of the table 21 is sandwiched between the table 21 and the plate-like part 26 and fixed therebetween.

When each micropin P is sandwiched and gripped between the table 21 and the plate-like part 26, a contact area of each micropin P relative to the plate-like part 26 and the table 21 is substantially equal to all the areas at the side surfaces of the portion where each micropin P is inserted into the groove 22, thereby securing a sufficient contact area, so that each micropin P can be gripped by the table 21 and the plate-like part 26 with certainty while it is fixed thereto.

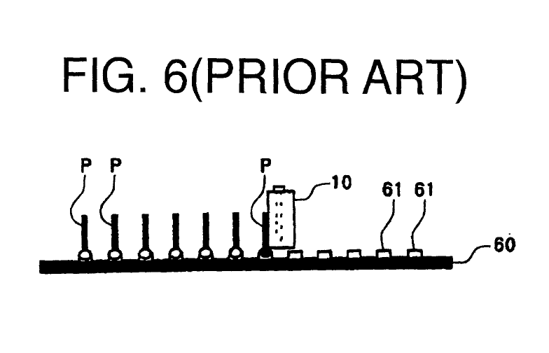

After each micropin P is gripped, the table 21 is moved by a moving unit, not shown, so that each micropin P is peeled off from the sheet 55 and is conveyed to a given mounting position of a contact board (see FIG. 6). During the conveyance of each micropin P, the operation of the vacuum generator, not shown, is continued so that each micropin P is reliably gripped by the table 21 and the plate-like part 26.

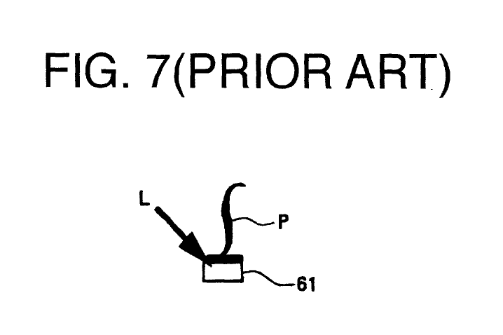

Thereafter, each micropin P is joined at a mounting position such as a pad 61 by welding and the like (see FIG. 7) and the operation of the vacuum generator is stopped upon completion of the joining. As a result, a pressure between the plate-like part 26 and the surface 21a of the able 21 is increased, so that the plate-like part 26 is moved away from the surface 21a of the table 21 as shown in FIG. 2 (A), so that the fixation of each micropin P by the chuck 20 is released.

Although the table 21 and the plate-like part 26 are made of respectively metal in the chuck 20 according to the preferred embodiment of the invention, they may be made of a material such as glass which is transparent and has a sufficient hardness. As a result, the posture of a gripped micropin P can be visually confirmed so that a mounting operation can be easily effected.

Further, since the groove 22 is defined in the table 21 according to the preferred embodiment of the invention, each micropin P is positioned and fixed relative to the table 21 by the groove 22. That is, when each micropin P is brought into contact with both surfaces and end surface of the groove 22, the posture of each micropin P can be stabilized and arranged in order. Accordingly, when the table 21 is positioned relative to the mounting position, the gripped micropin P is automatically positioned to the mounting position so that the mounting operation is more easily effected.

The groove 22 maybe not formed in the table 21 but may be formed in the plate-like part 26. If there is employed a construction that the position of the microcontact such as gripped micropin P is detected in a separate way and it is controlled to be positioned to a mounting position, the microcontact may be gripped between the surfaces of the plate-like member and the table without defining the groove 22 in the table 21 and the plate-like part 26.

If the chuck is fixed to an XYZ stage and the like while the groove 22 of the chuck is directed vertically downward in a state where air is sucked, the mounting operation is more easily effected.

Further, if a suction force (negative pressure) when sucking air is changed, a force to press down the plate-like member toward the surface of the table can be freely changed. Utilizing this, microcontacts such as various micropins and the like which are different in shape can be gripped and conveyed to a given mounting position.

The press-down force operation between the plate-like part 26 and the table 21 is not always produced by a suction of the suction means but may be produced by using, e.g., an appropriate actuator.

As set forth above in detail, according to the first aspect of the invention, parts having a simple construction are used which is economical, and the chuck for microcontacts which can be grip the microcontacts with a stable strong holding force and convey them to a given mounting position can be provided.

According to the second aspect of the invention, since the suction means in the conventional chuck mechanism can be used, and hence the chuck for microcontacts having high general purpose can be provided.

According to the third aspect of the invention, since a holding force between the body and an elastic member can be changed by changing a suction force by the suction means so that a fixed holding force for microparts can be obtained regardless of kind and accuracy of the parts.

According to the fourth aspect of the invention, the positioning and fixation of the microcontact can be effected utilizing the groove with certainty.

According to the fifth aspect of the invention, when the spacer is inserted between the body and elastic member so that a holding force exceeding a pressure caused by the suction means can be obtained.

What is claimed is:

1. A chuck for microcontacts for gripping and conveying each microcontact comprising a movably supported body, an elastic member provided to be movable toward or away from the body, and a microcontact fixing part formed between the body and the elastic member for sandwiching each microcontact therebetween.

2. The chuck for microcontacts according to claim 1, further comprising suction means provided on the body for sucking the elastic member, wherein the elastic member is moved toward or away from the body by the suction means.

3. The chuck for microcontacts according to claim 2, wherein a suction force produced by the suction means is changeable, and when the suction force produced by the suction means is changed, a force for holding each microcontact between the body and the elastic member is changed.

4. The chuck for microcontacts according to any claims 1 to 3, wherein the microcontact fixing part is a groove defined in the body or the elastic member.

5. The chuck for microcontacts according to any claims 1 to 4, wherein a spacer is sandwiched between the body and elastic member, and the elastic member is moved toward or away from the body when the elastic member is elastically deformed.
